(19) United States
(12) Patent Application Publication
(10) Pub. No.: US 2018/0241155 A1
(43) Pub. Date: Aug. 23, 2018

(54) MOVABLE CONNECTOR

(71) Applicant: IRISO ELECTRONICS CO., LTD., Kanagawa (JP)

(72) Inventors: Hitoshi Suzuki, Kanagawa (JP); Hiroaki Kobayashi, Kanagawa (JP); Yoshiyuki Ogura, Kanagawa (JP); Tomomitsu Saito, Kanagawa (JP); Daichi Shimba, Kanagawa (JP)

(73) Assignee: IRISO ELECTRONICS CO., LTD., Kanagawa (JP)

(21) Appl. No.: 15/886,983

(22) Filed: Feb. 2, 2018

(30) Foreign Application Priority Data
Feb. 17, 2017 (JP) 2017-028173

(51) Int. Cl. H01R 13/631; H01R 13/502; H01R 13/11

(52) U.S. Cl. CPC H01R 13/6315; H01R 13/11; H01R 13/502

(57) ABSTRACT

A movable connector with which an insertion force of a connection object that places a load on a solder portion can be reduced, that has a floating function, and that can be reduced in size is provided. As a result of a pushing operation in which an operation housing is pushed into a fixed housing, a relay terminal is conductively connected to a substrate connection terminal, which is in conductive contact with a substrate, and a pin terminal, which is disposed in a movable housing and serves as the connection object, in the movable housing. Accordingly, the overall size of the movable connector can be reduced. In addition, the insertion force applied to the pin terminal is not applied to the solder portion by which the movable connector is fixed to the substrate, so that conduction failure does not occur.

### BACKGROUND OF THE INVENTION

### 1. Field of the Invention

The present invention relates to a connector having a floating function.

### 2. Description of the Related Art

A bottom entry connector is an example of a known connector that connects a connection object to a circuit on a substrate (see, for example, Japanese Unexamined Patent Application Publication No. 2015-146289, FIG. 3). This type of connector includes a terminal that comes into conductive contact with a connection object (for example, a pin terminal of an electric element) and a housing that holds the terminal. A surface of the housing that opposes the substrate has an insertion opening that communicates with a through hole in the substrate. To conductively connect the connection object to the connector, the connection object is inserted into the housing through the through hole and the insertion opening in the housing from the back of the substrate, and is brought into conductive contact with a contact portion of the terminal in the housing.

The connector according to Japanese Unexamined Patent Application Publication No. 2015-146289 includes a female type terminal (10) including a box-shaped first female terminal (11) and a box-shaped second female terminal (12) that are arranged next to each other. The first female terminal (11) is in conductive contact with a first male type terminal (3) mounted on a substrate. The second female terminal (12) is in conductive contact with a second male type terminal (4) that is inserted through a through hole in the substrate. Since the first female terminal (11) and the second female terminal (12) of the female type terminal (10) are box-shaped, the overall size of the connector including them is large. Also, the first female terminal (11) and the second female terminal (12) are arranged side by side along the substrate, and this also increases the size of the connector. This connector also includes a coupling spring (20) that couples the first female terminal (11) and the second female terminal (12) to each other and that provides a floating function. When the connector is vibrated, the first female terminal (11) and the second female terminal (12) are independently movable. However, since the coupling spring (20) is S-shaped, the spring length thereof cannot be easily increased.

### SUMMARY OF THE INVENTION

The present invention has been made in light of the above-described related art. An object of the present invention is to provide a movable connector that has a floating function and that can be reduced in size.

To achieve the above-described object, the present invention has the following characteristics.

A movable connector according to the present invention includes a fixed housing to be fixed to a substrate; a movable housing disposed in the fixed housing and into which a connection object is to be inserted; a substrate connection terminal including a substrate connection portion to be soldered to the substrate, a support spring that supports the movable housing so that the movable housing is movable with respect to the fixed housing, and an inner contact section disposed in the movable housing; an operation housing that is combined with the movable housing as a result of a pushing operation in which the operation housing is pushed into an interior space of the fixed housing; and a relay terminal that moves together with the operation housing in the pushing operation and comes into conductive contact with the connection object and the inner contact section of the substrate connection terminal in the movable housing.

According to present invention, the relay terminal can be brought into conductive contact with the connection object and the inner contact section of the substrate connection terminal in the movable housing. Therefore, the overall size of the connector can be made smaller than the connector according to the related art in which the above-described first female terminal and the second female terminal are arranged in parallel. In addition, since the relay terminal is brought into conductive contact with the connection object and the inner contact section of the substrate connection terminal as a result of the pushing operation of the operation housing, the relay terminal can be easily brought into conductive contact with the connection object. In addition, since the connection object can be placed in the movable housing without being in conductive contact with the relay terminal before the pushing operation, the connector can be formed as a zero insertion force (ZIF) connector. Furthermore, since the relay terminal is moved and brought into conductive contact with the connection object placed in the movable housing as a result of the pushing operation of the operation housing, the insertion force applied to the connection object is not applied to the solder portion by which the movable connector is fixed to the substrate. Accordingly, conduction failure does not occur.

The interior space of the fixed housing according to the present invention may include a housing accommodating section that accommodates the movable housing and the operation housing and a support spring accommodating section in which the support spring extends.

According to present invention, since the support spring accommodating section may be provided separately from the housing accommodating section that accommodates the movable housing and the operation housing, the spring length can be increased without making the shape of the support spring complex.

The substrate connection terminal according to the present invention may include a first contact piece that comes into pressure contact with the relay terminal in the pushing operation.

According to present invention, the first contact piece of the substrate connection terminal comes into pressure contact with the relay terminal. Therefore, even when the movable connector is vibrated or receives an impact, the conductive contact between the first contact piece and the relay terminal can be reliably maintained due to the contact pressure applied by the first contact piece. The first contact piece may be formed as a cantilever-shaped contact spring.

The relay terminal according to the present invention may include a second contact piece that comes into pressure contact with the connection object and the substrate connection terminal in the pushing operation.

According to present invention, the second contact piece of the relay terminal comes into pressure contact with both the connection object and the substrate connection terminal. Therefore, even when the movable connector is vibrated or receives an impact, the conductive contact between the second contact piece and each of the connection object and the substrate connection terminal can be reliably maintained due to the contact pressure applied by the second contact piece. The second contact piece may be formed as a cantilever-shaped contact spring.

The second contact piece according to the present invention may include a first contact portion that comes into conductive contact with the connection object; a second contact portion that comes into pressure contact with the substrate connection terminal; and a spring portion that connects the first contact portion to the second contact portion and exerts a reaction force that presses the first contact portion against the connection object when the second contact portion comes into pressure contact with the substrate connection terminal.

According to present invention, the first contact portion can be pressed against the connection object by using the reaction force generated when the second contact portion comes into pressure contact with the substrate connection terminal. Thus, the contact pressure between the first contact portion and the connection object can be increased.

The relay terminal according to the present invention may include a projection, and the operation housing may have a retaining groove in which the projection is retained in a movable manner with a gap provided therebetween. The relay terminal may be movable with respect to the operation housing over a range defined by the gap.

According to present invention, the relay terminal is not fixed to the operation housing, and is movable. Therefore, even when the substrate connection terminal or the connection object comes into contact with the relay terminal in a displaced manner, the relay terminal is capable of moving so as to absorb the displacement. Thus, the connection reliability of the conductive contact can be increased.

The substrate connection terminal according to the present invention may include a first base portion held by the movable housing, and the relay terminal may include a second base portion held by the operation housing. The first base portion and the second base portion may be arranged in a pushing direction in which the operation housing is pushed in the pushing operation.

According to present invention, the first base portion of the substrate connection terminal and the second base portion of the relay terminal are arranged in the pushing direction. In other words, the substrate connection terminal and the relay terminal are arranged in series in the pushing direction. Therefore, the dimension of the movable connector in a direction that crosses the pushing direction can be reduced.

The operation housing and the movable housing according to the present invention may include temporarily-fitted-state retaining portions that restrain a movement of the operation housing in a pushing direction in which the operation housing is pushed in the pushing operation and a pulling direction that is opposite to the pushing direction in a temporarily fitted state before the operation housing and the movable housing are combined together in a completely fitted state.

According to present invention, the temporarily-fitted-state retaining portions restrain the operation housing from being pushed into or pulled out of the movable housing. Therefore, the operation housing can be prevented from falling, for example, in the temporarily fitted state.

The operation housing and the movable housing according to the present invention include completely-fitted-state retaining portions that restrain a movement of the operation housing in a pulling direction in which the operation housing is pulled out of the movable housing in a completely fitted state in which the operation housing and the movable housing are combined together.

According to present invention, the completely-fitted-state retaining portions restrain the operation housing from being pulled out of the movable housing in the completely fitted state. Thus, the completely fitted state can be reliably maintained.

The movable connector of the present invention is structured such that the relay terminal is brought into conductive contact with the connection object and the inner contact section of the substrate connection terminal in the movable housing. Therefore, the overall size of the movable connector can be made smaller than the connector according to the related art. In addition, the insertion force applied to the connection object is not applied to the solder portion by which the movable connector is fixed to the substrate, so that the reliability of conductive connection can be increased. In addition, the spring length can be increased without making the shape of the support spring complex, so that a floating function for softly supporting the movable housing can be provided.

### BRIEF DESCRIPTION OF THE DRAWINGS

FIG. 1 is an exploded perspective view of a movable connector according to a first embodiment showing the front, right, and top sides.

FIG. 2 is a front view of the movable connector illustrated in FIG. 1.

FIG. 3 is a plan view of the movable connector illustrated in FIG. 1.

FIG. 4 is a bottom view of the movable connector illustrated in FIG. 1.

FIG. 5 is a perspective view of a relay terminal included in the movable connector illustrated in FIG. 1.

FIG. 6 is an enlarged sectional view of FIG. 2 taken along line VI-VI.

FIG. 7 is an enlarged sectional view of FIG. 4 taken along line VII-VII.

FIG. 8 is an enlarged sectional view of FIG. 6 taken along line VIII-VIII.

FIG. 9 is an enlarged sectional view corresponding to FIG. 6, illustrating the movable connector of FIG. 1 in a fitting process.

FIG. 10 is an enlarged sectional view corresponding to FIG. 6, illustrating the movable connector in a completely fitted state after the state illustrated in FIG. 9.

FIG. 11 is an exploded perspective view of a movable connector according to a second embodiment showing the front, right, and top sides.

FIG. 12 is a perspective view of a relay terminal included in the movable connector illustrated in FIG. 11.

FIG. 13 is an enlarged sectional view corresponding to FIG. 6, illustrating the movable connector of FIG. 11 in a fitting process.

FIG. 14 is an enlarged sectional view corresponding to FIG. 6, illustrating the movable connector in a completely fitted state after the state illustrated in FIG. 13.

### DESCRIPTION OF THE PREFERRED EMBODIMENTS

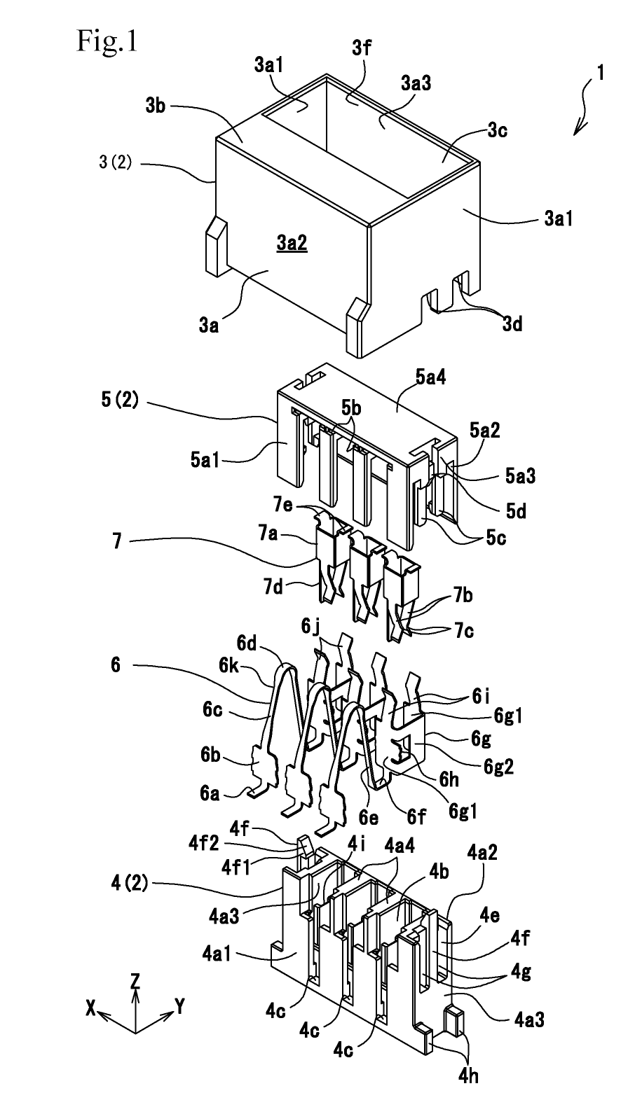

Embodiments of the present invention will now be described with reference to the drawings. Bottom entry movable connectors 1 according to the embodiments will be described. In this specification, claims, and drawings, the direction in which terminals of the movable connector 1 illustrated in FIG. 1 are arranged (left-right direction) is defined as an X direction, a depth direction of the movable connector 1 (front-back direction) is defined as a Y direction, and a height direction of the movable connector 1 (up-down direction) is defined as a Z direction. The definitions of the left-right, front-back, and up-down directions do not limit the direction in which the movable connector according to the present invention is mounted or used.

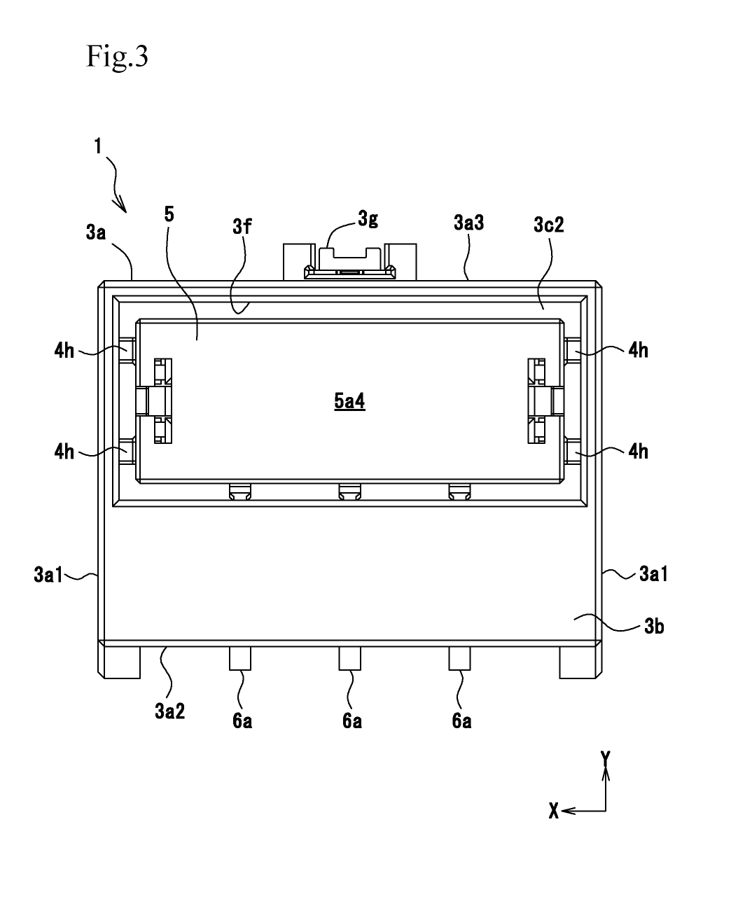

### First Embodiment (FIGS. 1 to 10)

### Structure of Movable Connector 1

The movable connector 1 includes a housing 2, which is a molded body made of a rigid resin. The housing 2 includes a fixed housing 3, a movable housing 4, and an operation housing 5. Reference numeral 6 denotes substrate connection terminals formed of metal pieces, and 7 denotes relay terminals formed of metal pieces. The substrate connection terminals 6 are fixed to the fixed housing 3 and the movable housing 4. The relay terminals 7 are held by the operation housing 5. Fixed Housing 3

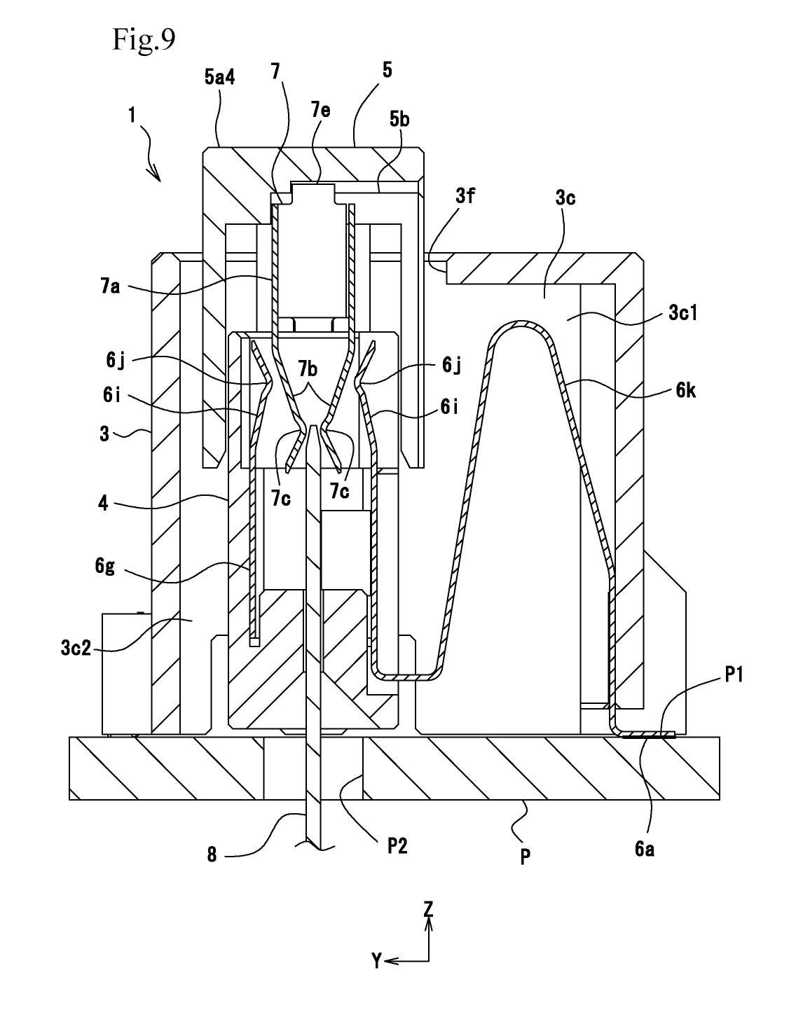

The fixed housing 3 is mounted on a substrate P (FIG. 9). The fixed housing 3 is box-shaped, and includes a tubular wall 3a and a top portion 3b that covers a front section in the Y direction at the top end of the tubular wall 3a. The fixed housing 3 defines an interior space 3c therein.

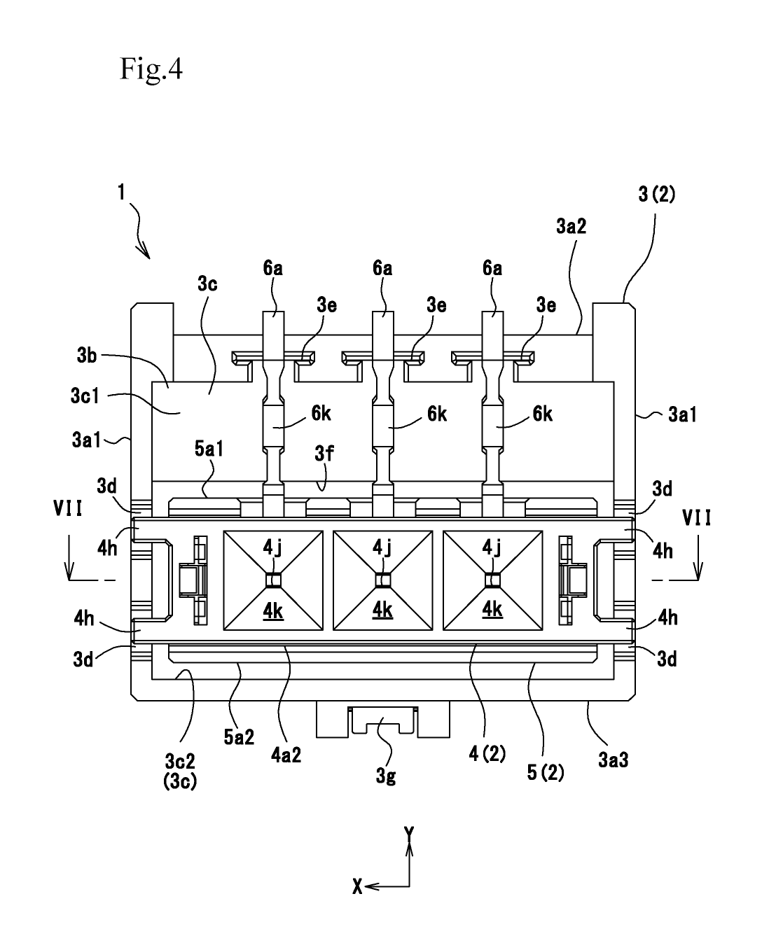

The tubular wall 3a includes left and right side walls 3a1 having engagement recesses 3d at the bottom ends thereof. The engagement recesses 3d engage with engagement projections 4h (described below) of the movable housing 4. The tubular wall 3a also includes a front wall 3a2 and a back wall 3a3. The front wall 3a2 has groove-shaped terminal fixing portions 3e on the inner side thereof. The terminal fixing portions 3e retain fixed-housing fixing portions 6b (described below) of the substrate connection terminals 6 in the X direction (FIG. 4).

The top portion 3b covers support springs 6k (described below) of the substrate connection terminals 6 from above to protect the support springs 6k by preventing them from being exposed to the outside. The opening at the top end of the tubular wall 3a where the top portion 3b is not formed serves as an insertion opening 3f in which the operation housing 5 is inserted. The insertion opening 3f is larger than the outer periphery of the operation housing 5.

In the interior space 3c of the fixed housing 3 having the above-described structure, the section below the top portion 3b serves as a support spring accommodating section 3c1 in which the support springs 6k of the substrate connection terminals 6 extend and which allows elastic deformation of the support springs 6k. The section below the insertion opening 3f serves as a housing accommodating section 3c2 that accommodates the operation housing 5 and the movable housing 4. Thus, in the interior space 3c of the fixed housing 3, a plurality of accommodating sections, which are the support spring accommodating section 3c1 and the housing accommodating section 3c2, are arranged next to each other in the Y direction. Since the interior space 3c includes the support spring accommodating section 3c1 separately from the housing accommodating section 3c2, the support spring accommodating section 3c1 can be used as a space in which the support springs 6k extend, bend, and move. Thus, the spring length of the support springs 6k can be increased without making the shape of the support springs 6k complex.

A fixing piece 3g that is soldered to the substrate P is attached to the back wall 3a3 of the fixed housing 3. The fixing piece 3g is fixed to the substrate P by a solder portion (not shown).

### Movable Housing 4

Similar to the fixed housing 3, the movable housing 4 is arranged so that the longitudinal direction thereof is the X direction, and includes a front wall 4a1, a back wall 4a2, and left and right side walls 4a3. Two partition walls 4a4 that extend in the Y direction are formed between the front wall 4a1 and the back wall 4a2. Thus, the movable housing 4 includes three connection chambers 4b that are partitioned from each other in the X direction. Each connection chamber 4b receives a pin terminal 8, which serves as a “connection object”, and serves as a space in which the pin terminal 8 comes into conductive contact with a pair of contact portions 7c (described below) of a corresponding one of the relay terminals 7.

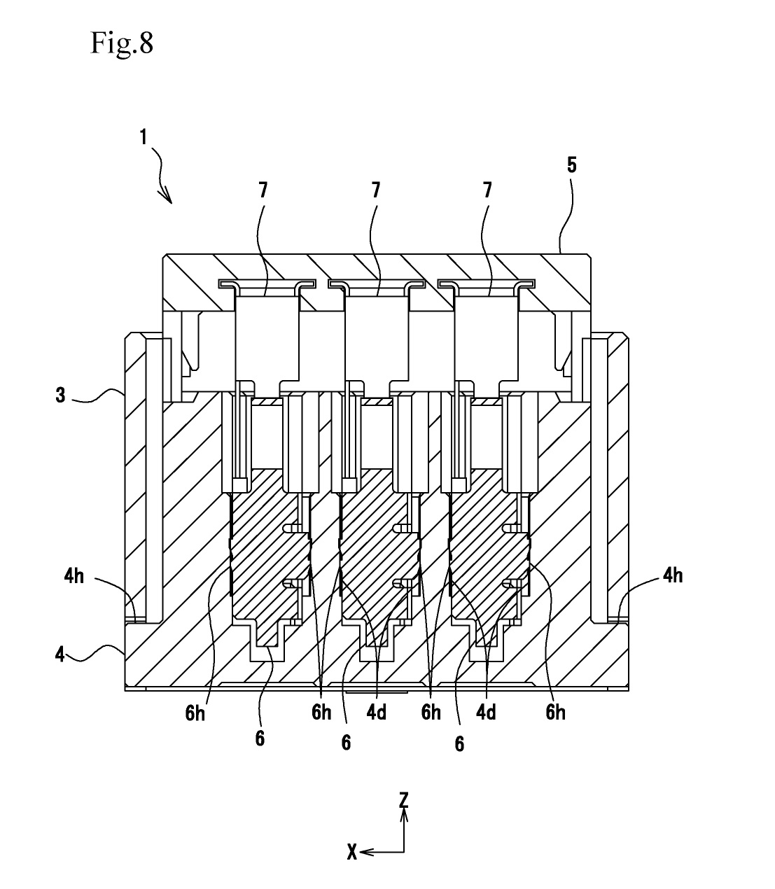

Insertion slits 4c are formed in the front wall 4a1. The insertion slits 4c connect the connection chambers 4b to the outside of the movable housing 4 in the Y direction, and accommodate horizontally bent portions 6f of the support springs 6k of the substrate connection terminals 6. The front wall 4a1 has groove-shaped terminal fixing portions 4d on the inner side thereof (FIG. 8). The terminal fixing portions 4d retain movable-housing fixing portions 6h (described below) of the substrate connection terminals 6 in the X direction.

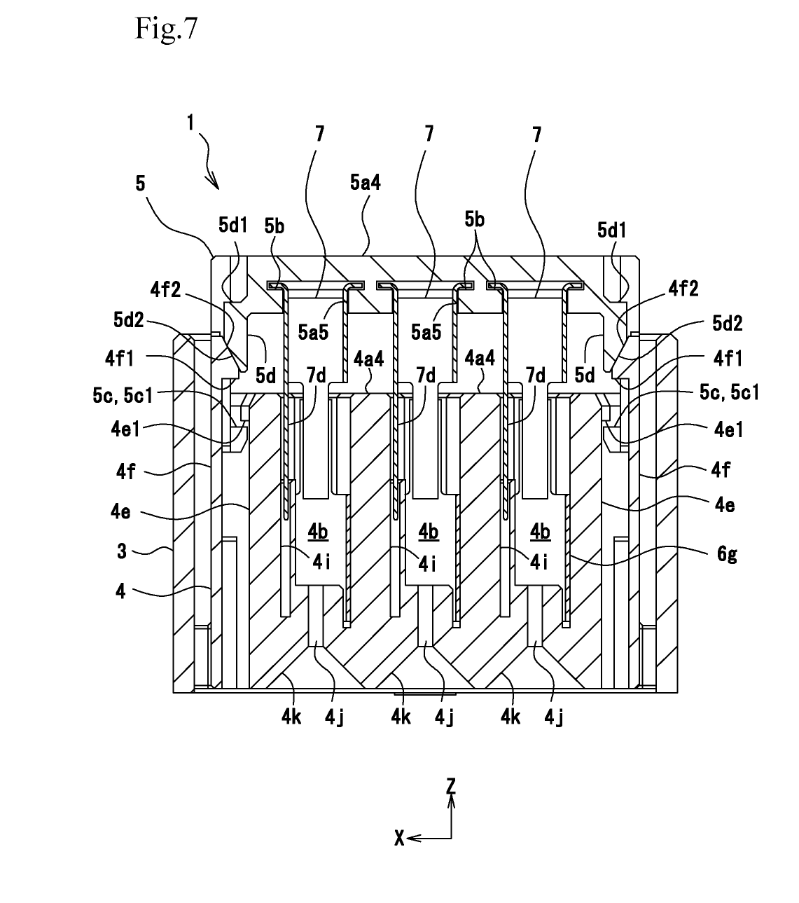

Long groove-shaped recesses 4e that extend in the Z direction are formed in the left and right side walls 4a3 (FIGS. 1 and 7). Engagement steps 4e1, which serve as “temporarily-fitted-state retaining portions” of the movable housing 4, are formed at the top edges of the recesses 4e (FIG. 7).

The side walls 4a3 have lock arms 4f that extend in the Z direction so as to oppose the respective recesses 4e. Long groove-shaped guide portions 4g, which extend in the Z direction, are formed between each recess 4e and side surfaces of the corresponding lock arm 4f that oppose each other in the Y direction (FIG. 1).

The engagement projections 4h are formed at the front and back ends of the bottom edge of each side wall 4a3. When the movable housing 4 is excessively moved in the interior space 3c of the fixed housing 3 in the Y or Z direction, the engagement projections 4h engage with the above-described engagement recesses 3d in the fixed housing 3 to serve as stoppers for stopping the movement.

Each connection chamber 4b has a sheath-shaped portion 4i that receives a thin-plate-shaped movement restricting piece 7d (described below) of the corresponding relay terminal 7. Each connection chamber 4b also has an insertion hole 4j for receiving the connection object in the bottom surface thereof. The insertion hole 4j has a tapered portion 4k, which guides insertion of the pin terminal 8, at the entrance thereof.

### Operation Housing 5

Similar to the fixed housing 3 and the movable housing 4, the operation housing 5 is arranged so that the longitudinal direction thereof is the X direction, and includes a front wall 5a1, a back wall 5a2, left and right side walls 5a3, and a top wall 5a4. Two partition walls 5a5 are formed between the front wall 5a1 and the back wall 5a2 (FIG. 7). The partition walls 5a5 extend in the Y direction and project slightly downward in the Z direction from the bottom surface of the top wall 5a4. Retaining grooves 5b that extend in the Y direction are formed in proximal end portions of the partition walls 5a5 and inner surfaces of the left and right side walls 5a3 that oppose the proximal end portions in the X direction. Projections 7e of the relay terminals 7 are inserted in the retaining grooves 5b.

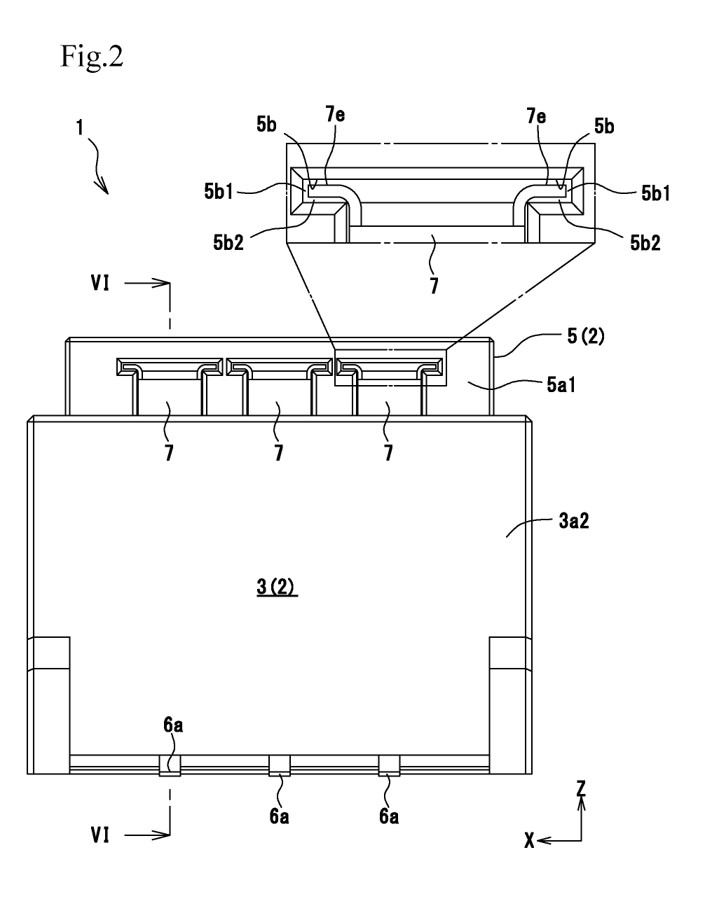

Each of the left and right side walls 5a3 has two stopper pieces 5c that extend downward in the Z direction from the side adjacent to the top wall 5a4 (FIGS. 1 and 7). The stopper pieces 5c serve as “temporarily-fitted-state retaining portions” of the operation housing 5. The stopper pieces 5c extend into the guide portions 4g on both sides of the above-described lock arms 4f of the movable housing 4. The stopper pieces 5c move along the guide portions 4g to guide the movement of the operation housing 5 in the Z direction. When the operation housing 5 is pulled in a direction away from the movable housing 4 in a temporarily fitted state (FIGS. 2 and 6 to 9) in which the operation housing 5 and the movable housing 4 are not yet completely fitted together, engagement lugs 5c1 of the stopper pieces 5c come into contact with the engagement steps 4e1 of the movable housing 4 and prevent the operation housing 5 from being pulled out of the movable housing 4 (FIG. 7).

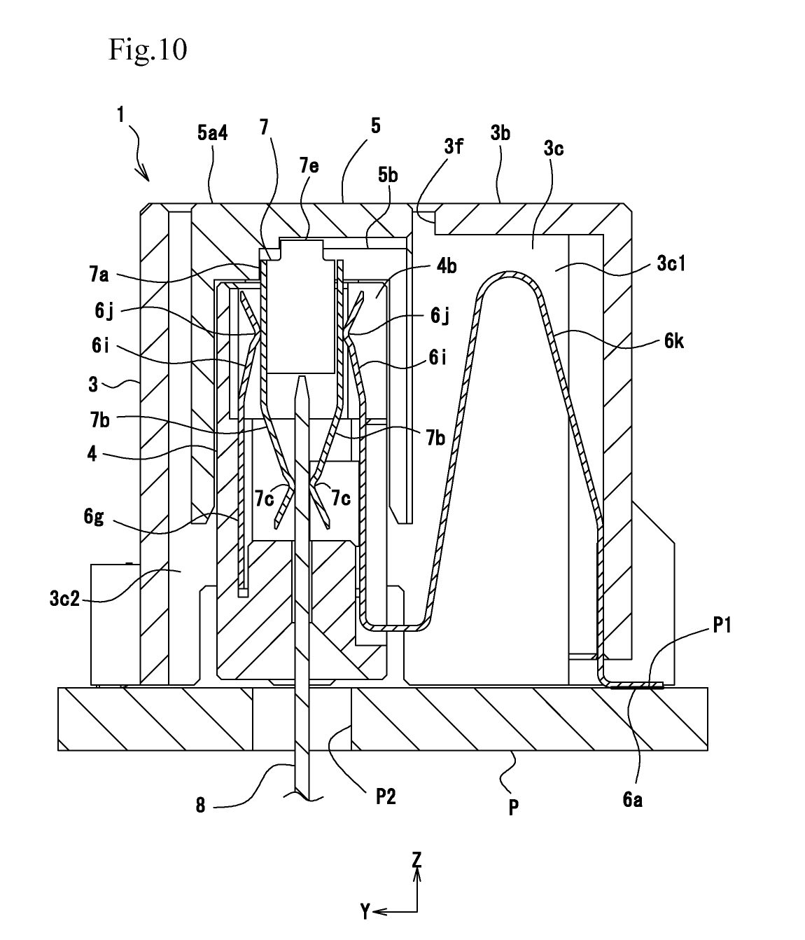

Each side wall 5a3 also has a locking projection 5d. The locking projection 5d has an engagement surface 5d1 that engages with an engagement lug 4f1 of the corresponding lock arm 4f of the movable housing 4 in the completely fitted state in which the operation housing 5 is completely fitted to the movable housing 4 as a result of a pushing operation in which the operation housing 5 is pushed into the interior space 3c of the fixed housing 3. The completely fitted state illustrated in FIG. 10 is maintained by the engagement between the engagement lug 4f1 and the engagement surface 5d1 in the pulling direction. The locking projection 5d and the engagement surface 5d1 thereof serve as “completely-fitted-state retaining portions” of the operation housing 5, and the lock arm 4f and the engagement lug 4f1 thereof serve as “completely-fitted-state retaining portions” of the movable housing 4.

The locking projection 5d also has an inclined surface 5d2. In the above-described temporarily fitted state (FIGS. 2 and 6 to 9), the inclined surface 5d2 is in contact with an inclined surface 4f2 provided at the top end of the lock arm 4f, and restricts the pushing operation of the operation housing 5 to maintain the temporarily fitted state. To fit the operation housing 5 to the movable housing 4, the operation housing 5 in the temporarily fitted state is pushed into the interior space 3c of the fixed housing 3. As a result of the pushing operation, the inclined surface 5d2 of the locking projection 5d pushes the inclined surface 4f2 of the lock arm 4f in the Z direction, and the lock arm 4f is outwardly bent due to the inclined surfaces 5d2 and 4f2 that are in contact with each other. When the locking projection 5d passes the engagement lug 4f1 of the lock arm 4f, the lock arm 4f returns from the bent state, and the engagement surface 5d1 of the locking projection 5d engages with the engagement lug 4f1 of the lock arm 4f. Thus, the operation housing 5 and the movable housing 4 are set to the completely fitted state.

The top wall 5a4 serves as a pushing operation surface in the pushing operation of the operation housing 5. To facilitate the pushing operation even when the movable connector 1 is small, the top wall 5a4 is formed to have a flat surface over the entire area thereof. When the operation housing 5 and the movable housing 4 are in the completely fitted state, the top wall 5a4 is positioned to be flush with the top portion 3b of the fixed housing 3. When the top wall 5a4 is positioned so as to project from the top portion 3b of the fixed housing 3, it means that the operation housing 5 and the movable housing 4 are not yet completely fitted together. Therefore, whether or not the completely fitted state is established can be determined by visually checking the position of the top wall 5a4.

### Substrate Connection Terminals 6

The substrate connection terminals 6 are arranged in parallel in the X direction in the movable connector 1. The substrate connection terminals 6 have the same shape. More specifically, each substrate connection terminal 6 includes a substrate connection portion 6a, the fixed-housing fixing portion 6b, an outer vertical portion 6c, an acutely bent portion 6d, an inner vertical portion 6e, the horizontally bent portion 6f, a base portion 6g that serves as a “first base portion”, the movable-housing fixing portions 6h, a pair of elastic arms 6i, and a pair of contact portions 6j.

The substrate connection portion 6a is conductively connected to a circuit on the substrate P by being fixed to the substrate P by a solder portion P1 (FIG. 9). The fixed-housing fixing portion 6b is press-fitted to and held by a corresponding one of the terminal fixing portions 3e on the inner surface of the front wall 3a2 of the fixed housing 3, so that one end of the substrate connection terminal 6 is fixed to the fixed housing 3. The outer vertical portion 6c, the acutely bent portion 6d, the inner vertical portion 6e, and the horizontally bent portion 6f constitute the support spring 6k that elastically supports the movable housing 4 and the operation housing 5 so that the movable housing 4 and the operation housing 5 are movable with respect to the fixed housing 3. The support spring 6k is bent in an inverted U-shape in the support spring accommodating section 3c1 of the fixed housing 3, and enables the movable housing 4 and the operation housing 5 to move in the X, Y, and Z directions by being elastically deformed in the X, Y, and Z directions in the support spring accommodating section 3c1. The horizontally bent portion 6f linearly extends in the Y direction above a corresponding one of the above-described insertion slits 4c in the movable housing 4. The base portion 6g includes a pair of plate pieces 6g1 that extend in the X direction and oppose each other in the Y direction and a plate piece 6g2 that extends in the Y direction and connects the plate pieces 6g1. The front plate piece 6g1 has a plurality of press-fitting projections on side edges thereof, the press-fitting projections being press-fitted to the terminal fixing portions 4d of the movable housing. The press-fitting projections serve as the movable-housing fixing portions 6h. The plate pieces 6g1 are connected to proximal ends of the elastic arms 6i at the top edges thereof. The elastic arms 6i function as spring pieces that support the contact portions 6j, which are bent in a sideways V-shape, in a movable manner, and exert a contact pressure for bringing the contact portions 6j into pressure contact with the corresponding relay terminal 7. The elastic arms 6i and the contact portions 6j serve as “inner contact sections” and “first contact pieces” according to the present invention. The contact portions 6j come into pressure contact with a base portion 7a of the relay terminal 7 so as to clamp the base portion 7a in the Y direction.

### Relay Terminal 7

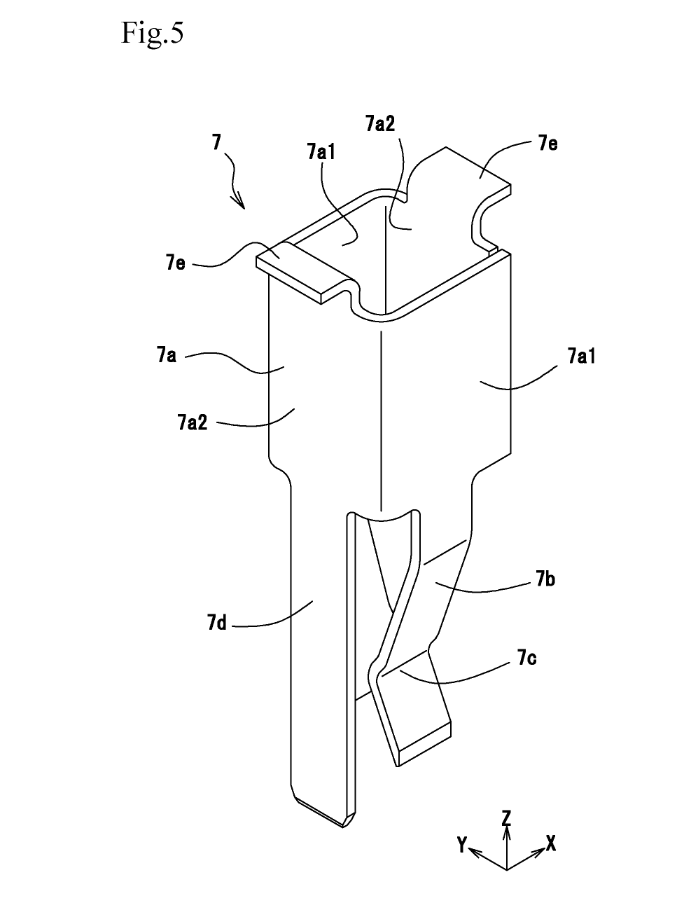

As illustrated in the enlarged view of FIG. 5, each relay terminal 7 includes the base portion 7a, which serves as a “second base portion”, a pair of elastic arms 7b, the pair of contact portions 7c, the movement restricting piece 7d, and the projections 7e.

The base portion 7a has a rectangular tubular shape, and is capable of being inserted into the base portion 6g of the corresponding substrate connection terminal 6 in a nested manner. The base portion 7a includes a pair of plate pieces 7a1 that extend in the X direction. The plate pieces 7a1 are connected to proximal ends of the elastic arms 7b, which extend downward in the Z direction, at the bottom edges thereof. The elastic arms 7b function as spring pieces that support the contact portions 7c, which are bent in a sideways V-shape, in a movable manner, and exert a contact pressure for bringing the contact portions 7c into pressure contact with the pin terminal 8, which serves as a connection object. The elastic arms 7b and the contact portions 7c serve as contact pieces. The contact portions 7c come into pressure contact with the pin terminal 8 so as to clamp the pin terminal 8 in the Y direction.

The base portion 7a also includes a pair of plate pieces 7a2 that extend in the Y direction and oppose each other in the X direction. The thin-plate-shaped movement restricting piece 7d, which extends downward in the Z direction, is formed on the left plate piece 7a2. The movement restricting piece 7d is inserted in the corresponding sheath-shaped portion 4i of the movable housing 4, so that the relay terminal 7 is prevented from moving excessively with respect to the movable housing 4 and falling. The projections 7e, which are bent in the X direction in the shape of outwardly projecting flanges, are formed at the top edges of the plate pieces 7a2. The projections 7e are inserted in the respective retaining grooves 5b in the operation housing 5. The projections 7e are retained in the retaining grooves 5b with gaps therebetween so that the relay terminal 7 is movable with respect to the movable housing 4. The projections 7e and the retaining grooves 5b serve as movable retaining portions that are provided on the relay terminal 7 and the movable housing 4 and retain the relay terminal 7 such that the relay terminal 7 is movable with respect to the movable housing 4.

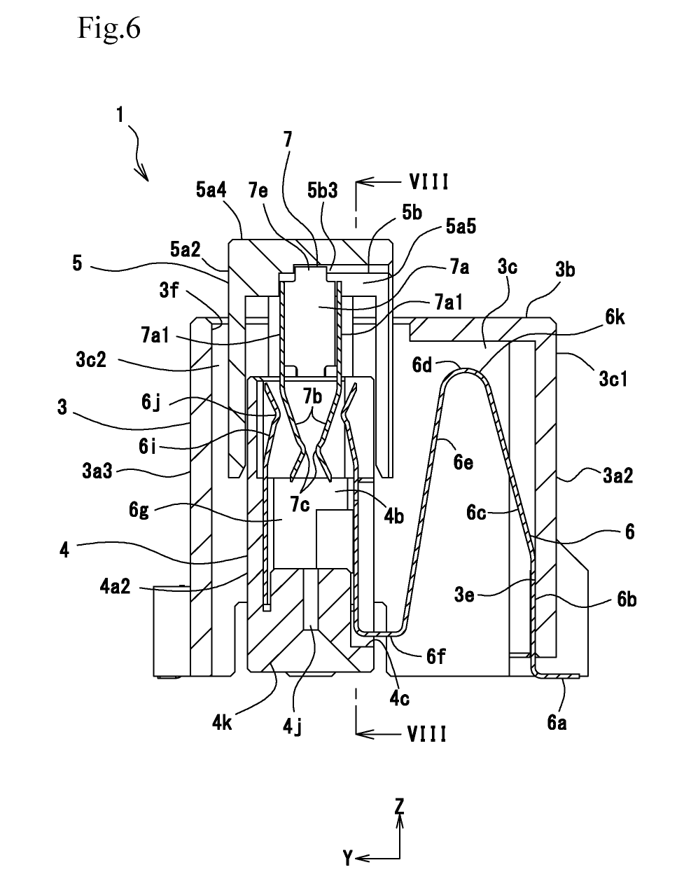

Thus, the relay terminal 7 is retained without being fixed to the operation housing 5 by inserting the projections 7e into the retaining grooves 5b in the operation housing 5. As illustrated in the enlarged view of FIG. 2, gaps 5b1 that extend in the X direction and gaps 5b2 that extend in the Z direction are formed between the projections 7e and the retaining grooves 5b. As illustrated in FIG. 6, gaps 5b3 that extend in the Y direction are also provided, so that the projections 7e are movable in the Y direction along the retaining grooves 5b. Thus, the relay terminal 7 is attached to the operation housing 5 with clearances that enable the relay terminal 7 to move in the X, Y, and Z directions. The movement restricting piece 7d and the sheath-shaped portion 4i also have gaps therebetween that extend in the X, Y, and Z directions. However, the sheath-shaped portion 4i functions as a stopper that prevents the movement restricting piece 7d from moving excessively forward in the Y direction.

### Operation and Effects of Movable Connector 1

The operation and effects of the above-described movable connector 1 according to the first embodiment will now be described.

### Assembly of Movable Connector 1

To assemble the movable connector 1, the movable-housing fixing portions 6h of the substrate connection terminals 6 are fixed to the terminal fixing portions 4d of the movable housing 4, and the relay terminals 7 are attached to the operation housing 5. Then, the operation housing 5 is attached to the movable housing 4 from above. At this time, the front wall 5a1 and the back wall 5a2 of the operation housing 5 are respectively guided along the front wall 4a1 and the back wall 4a2 of the movable housing 4, so that the operation housing 5 can be smoothly attached to the movable housing 4.

When the engagement lugs 5c1 of the stopper pieces 5c of the operation housing 5 slide over the engagement steps 4e1 of the movable housing 4, the stopper pieces 5c return from the bent state, and thereby provide a click sensation. Thus, the temporarily fitted state is established in which the engagement lugs 5c1 are engaged with the engagement steps 4e1 in the pulling direction of the operation housing 5 so that the operation housing 5 is prevented from being pulled out. In the temporarily fitted state, the two stopper pieces 5c at each side of the operation housing 5 are placed in the corresponding guide portions 4g, and the corresponding lock arm 4f of the movable housing 4 is placed between the two stopper pieces 5c, so that the operation housing 5 and the movable housing 4 are guided to move straight in the Z direction. In addition, the movement restricting piece 7d of each relay terminal 7 is inserted in the corresponding sheath-shaped portion 4i of the movable housing 4, so that the operation housing 5 can be smoothly attached to the movable housing 4 without causing each relay terminal 7 to fall therefrom.

Next, the operation housing 5 is inserted into the interior space 3c of the fixed housing 3 so that the operation housing 5 projects from the insertion opening 3f. Also, the fixed-housing fixing portions 6b of the substrate connection terminals 6 are press-fitted to the terminal fixing portions 3e of the fixed housing 3. The assembly of the movable connector 1 is completed by attaching the fixed housing 3 in the above-described manner. The movable connector 1 is mounted on the substrate P by soldering the fixing piece 3g and the substrate connection portions 6a of the substrate connection terminals 6 to the substrate P.

### Conductive Connection between Movable Connector 1 and Connection Object

The operation and effects of conductive connection between the movable connector 1 and each pin terminal 8 will now be described.

Each pin terminal 8 is inserted into the movable connector 1 through a through hole P2 from the back of the substrate P. Each insertion hole 4j in the movable housing 4 has the tapered portion 4k. Therefore, even when the central axis of the pin terminal 8 is displaced from the axis of the corresponding insertion hole 4j, the tapered portion 4k guides the pin terminal 8 to correct the insertion direction thereof.

When the pin terminal 8 is further inserted, as illustrated in FIG. 9, the pin terminal 8 stops before coming into contact with the contact portions 7c of the relay terminal 7. At this position, the pin terminal 8 is brought into conductive contact with and fitted to the movable connector 1. In this manner, the pin terminal 8 is inserted to a normal fitting position without contact with the substrate connection terminal 6 or the relay terminal 7. Thus, the movable connector 1 is a zero insertion force (ZIF) connector that does not receive an insertion force applied to the pin terminal 8. Accordingly, the insertion force applied to the pin terminal 8 is not applied to solder portions by which the movable connector 1 is fixed to the substrate P, more specifically, the solder portion (not shown) on the fixing piece 3g and the solder portion P1 on the substrate connection portion 6a of each substrate connection terminal 6. As a result, formation of cracks and separation of the movable connector 1 from the substrate P due to the insertion force can be prevented.

Next, the top wall 5a4 of the operation housing 5 that projects upward from the top portion 3b of the fixed housing 3 is pushed to move the operation housing 5 into the interior space 3c of the fixed housing 3. Accordingly, first, the pair of contact portions 7c of the relay terminal 7 come into pressure contact with the pin terminal 8 so as to clamp the pin terminal 8 in the Y direction. Shortly after that, the pair of contact portions 6j of the substrate connection terminal 6 come into pressure contact with the elastic arms 7b of the relay terminal 7. Accordingly, the elastic arms 7b are pressed toward the axis of the pin terminal 8 by the contact portions 6j, so that the contact pressure between the pin terminal 8 and the contact portions 7c is increased. Therefore, the contact portions 7c of the relay terminal 7 are moved downward in the Z direction while being pressed against the pin terminal 8 at a large contact pressure. At this time, foreign matter on the surface of the pin terminal 8 can be removed by the contact portions 7c (wiping effect). Thus, the contact portions 7c can be conductively connected to the pin terminal 8 in such a state that the foreign matter is removed.

When the operation housing 5 is further pushed, the engagement lugs 4f1 of the lock arms 4f of the movable housing 4 slide over the locking projections 5d of the operation housing 5, and the lock arms 4f return from the bent state to provide a click sensation. Accordingly, the engagement lugs 4f1 are engaged with the engagement surfaces 5d1 of the locking projections 5d in the pulling direction of the operation housing 5, so that the operation housing 5 is prevented from being pulled out. Thus, the operation housing 5 and the movable housing 4 are completely fitted to each other, and the pin terminal 8 is fitted (conductively connected) to the movable connector 1, as illustrated in FIG. 10. As described above, simply by pushing the operation housing 5 in the temporarily fitted state, the movable connector 1 can be conductively connected to the pin terminal 8, and the operation housing 5 and the movable housing 4 can be set to the completely fitted state.

In the completely fitted state, each relay terminal 7 is in conductive contact with the pin terminal 8 and the pair of contact portions 6j of the corresponding substrate connection terminal 6 in the corresponding connection chamber 4b of the movable housing 4. Accordingly, the overall size of the movable connector 1 can be made smaller than a connector according to the related art in which a first female terminal and a second female terminal are arranged in parallel.

In the above-described pushing operation of the operation housing 5, the operation housing 5 is ideally pushed straight toward the substrate P. However, since the movable connector 1 is small and the area of the top wall 5a4, which serves as the pushing operation surface, is even smaller, it is very difficult to push the top wall 5a4 at the center. Therefore, the top wall 5a4 is normally pushed obliquely at a position displaced from the center. However, even when a pushing force is applied so as to tilt the operation housing 5 and the movable housing 4, since the support springs 6k of the substrate connection terminals 6 are soft and elastically deformable, each pin terminal 8 can be fitted while allowing displacements of the operation housing 5 and the movable housing 4 in the tilted state.

Unlike a spring according to the related art, each support spring 6k has an inverted U-shape in the support spring accommodating section 3c1, which is obtained by dividing the interior space 3c of the fixed housing 3. Thus, each support spring 6k has a simple shape and a long spring length. Therefore, a floating function of softly supporting the movable housing 4 and the operation housing 5 can be realized.

The elastic arms 7b of each relay terminal 7 extend in the Z direction so that the pair of contact portions 7c of the relay terminal 7 are positioned inside the base portion 6g of the corresponding substrate connection terminal 6. The elastic arms 6i of each substrate connection terminal 6 extend from the base portion 6g so that the pair of contact portions 6j of the substrate connection terminal 6 come into pressure contact with the base portion 7a (plate pieces 7a1) of the corresponding relay terminal 7 so as to clamp the base portion 7a in the Y direction from the outside. Thus, the relay terminal 7, which is in conductive contact with the pin terminal 8, is conductively connected to the substrate connection terminal 6. In addition, since the pair of contact portions 6j of the substrate connection terminal 6 come into pressure contact with the relay terminal 7, the substrate connection terminal 6 can be retained so that it is not displaced relative to the relay terminal 7 even when the movable housing 4 is moved due to, for example, vibration. Accordingly, the position at which the contact portions 7c of the relay terminal 7 are in contact with the pin terminal 8 can be maintained, and reduction in connection reliability due to fine sliding abrasion of the contact portions 7c and the pin terminal 8 can be prevented.

With regard to the arrangement of the substrate connection terminal 6 and the relay terminal 7, the relay terminal 7, which is small enough to be insertable into the base portion 6g of the substrate connection terminal 6, is arranged so as to overlap the substrate connection terminal 6 in the Z direction, as described above. Accordingly, the dimension of the movable connector 1 in the Z direction can be reduced. The elastic arms 6i and the pair of contact portions 6j of the substrate connection terminal 6 and the elastic arms 7b and the pair of contact portions 7c of the relay terminal 7 extend from the edges of the base portions 6g and 7a that extend in the X direction, and oppose each other in the Y direction. Accordingly, compared to the case in which they do not oppose each other, the substrate connection terminal 6 and the relay terminal 7 can be arranged with smaller gaps therebetween. Thus, the dimension of the movable connector 1 in the Y direction can also be reduced.

If, for example, the projections 7e of the relay terminal 7 are press-fitted and fixed to the retaining grooves 5b in the operation housing 5, the central axis of the relay terminal 7 will be displaced from the midpoint between the contact portions 6j of the substrate connection terminal 6 in the Y direction unless the projections 7e are press-fitted to the retaining grooves 5b at an accurate position. In such a case, a large load is placed on one of the contact portions 6j and one of the elastic arms 6i of the substrate connection terminal 6, and there is a risk that fatigue of that elastic arm 6i will lead to a reduction in connection reliability. However, the relay terminal 7 is held in a movable manner, and is not fixed to the operation housing 5. Therefore, when the contact portions 6j of the substrate connection terminal 6 come into pressure contact of the relay terminal 7, the relay terminal 7 can be reliably arranged so that the central axis thereof coincides with the midpoint between the contact portions 6j.

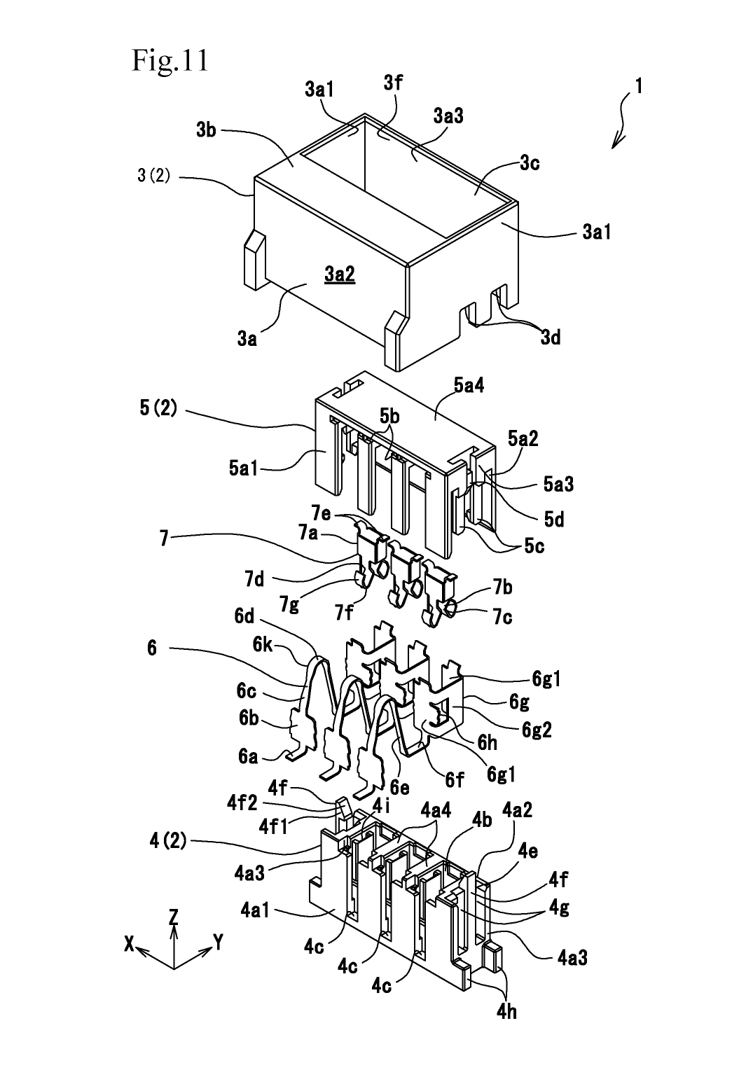

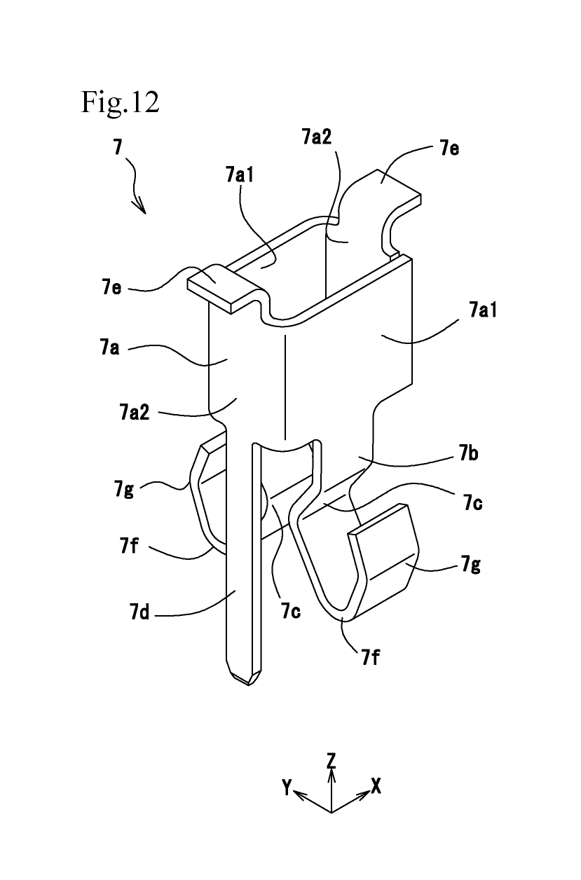

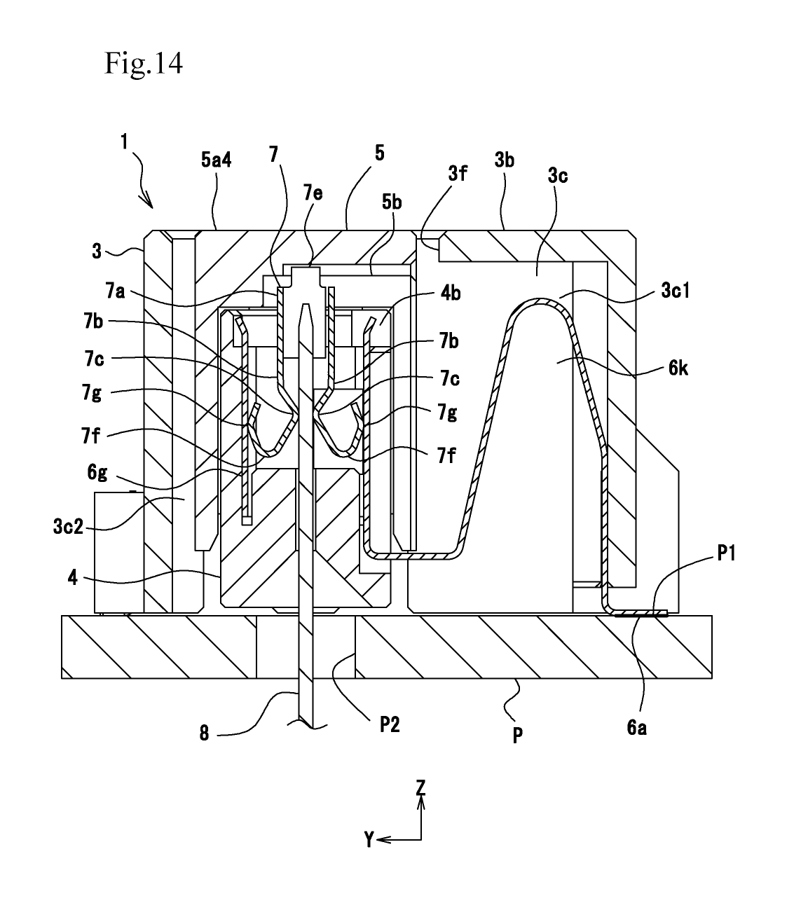

### Second Embodiment (FIGS. 11 to 14)

The second embodiment differs from the first embodiment in that each substrate connection terminal 6 does not include the pair of elastic arms 6i and the pair of contact portions 6j. The second embodiment also differs from the first embodiment in that each relay terminal 7 includes acutely bent portions 7f, which serve as “spring portions”, and a pair of terminal connection contact portions 7g, which serve as “second contact portions”. The acutely bent portions 7f extend from the pair of contact portions 7c, and are bent. The terminal connection contact portions 7g extend from the acutely bent portions 7f and come into conductive contact with the base portion 6g (plate pieces 6g1) of the corresponding substrate connection terminal 6. Other structures, operation, and effects of the second embodiment are the same as those of the first embodiment. Therefore, only the differences will be described.

In the first embodiment, the elastic arms 6i and the contact portions 6j of each substrate connection terminal 6 are brought into conductive contact with the corresponding relay terminal 7. In the second embodiment, the acutely bent portions 7f and the terminal connection contact portions 7g of each relay terminal 7 are brought into conductive contact with the corresponding substrate connection terminal 6. The elastic arms 7b, the contact portions 7c, the acutely bent portions 7f, and the terminal connection contact portions 7g of the relay terminal 7 according to the present embodiment serve as “second contact pieces” according to the present invention.

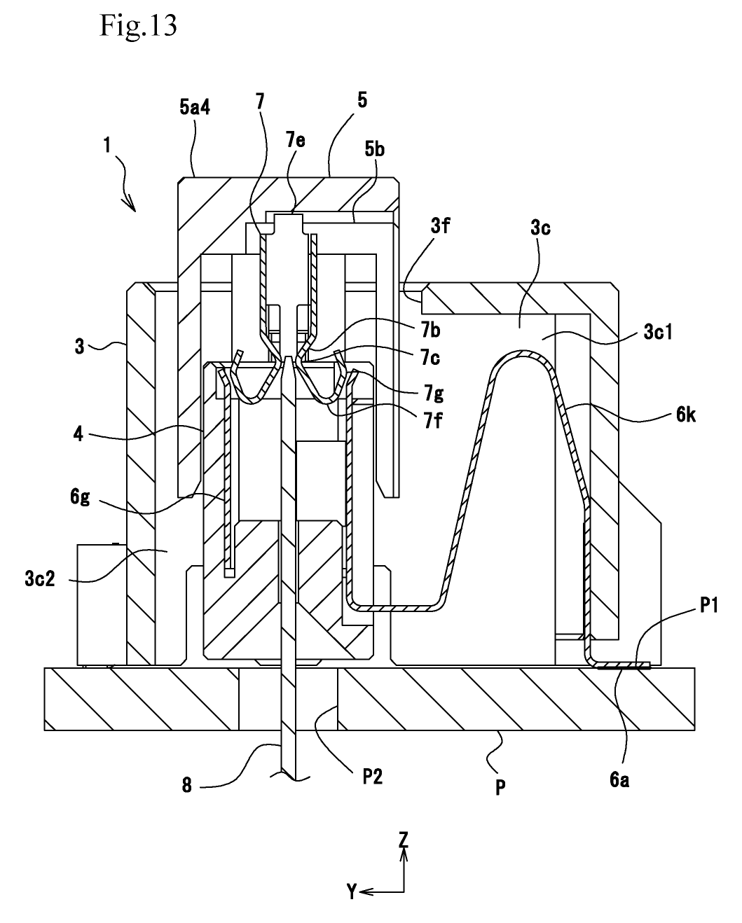

In the movable connector 1 according to the second embodiment, when the operation housing 5 in the temporarily fitted state illustrated in FIG. 13 is pushed, the contact portions 7c of the relay terminal 7 come into pressure contact with the pin terminal 8 and the terminal connection contact portions 7g come into pressure contact with the base portion 6g of the substrate connection terminal 6 at substantially the same time. When the terminal connection contact portions 7g come into pressure contact with the base portion 6g, the acutely bent portions 7f exert a reaction force that presses the contact portions 7c against the pin terminals 8. Thus, the contact portions 7c are in pressure contact with the pin terminal 8 at a large contact pressure, so that the position at which the contact portions 7c are in contact with the pin terminal 8 can be reliably maintained even when the movable housing 4 is moved due to, for example, vibration. The terminal connection contact portions 7g are also in pressure contact with the base portion 6g at a large contact pressure. This also contributes to maintaining the position at which the contact portions 7c are in contact with the pin terminal 8 when the movable housing 4 is moved due to, for example, vibration. Therefore, reduction in connection reliability due to fine sliding abrasion of the contact portions 7c and the pin terminal 8 can be prevented.

What is claimed is:

1. A movable connector comprising:
a fixed housing to be fixed to a substrate;
a movable housing disposed in the fixed housing and into which a connection object is to be inserted;
a substrate connection terminal including
a substrate connection portion to be soldered to the substrate,
a support spring that supports the movable housing so that the movable housing is movable with respect to the fixed housing, and
an inner contact section disposed in the movable housing;
an operation housing that is combined with the movable housing as a result of a pushing operation in which the operation housing is pushed into an interior space of the fixed housing; and
a relay terminal that moves together with the operation housing in the pushing operation and comes into conductive contact with the connection object and the inner contact section of the substrate connection terminal in the movable housing.

2. The movable connector according to claim 1, wherein the interior space of the fixed housing includes a housing accommodating section that accommodates the movable housing and the operation housing and a support spring accommodating section in which the support spring extends.

3. The movable connector according to claim 1, wherein the substrate connection terminal includes a first contact piece that comes into pressure contact with the relay terminal in the pushing operation.

4. The movable connector according to claim 1, wherein the relay terminal includes a second contact piece that comes into pressure contact with the connection object and the substrate connection terminal in the pushing operation.

5. The movable connector according to claim 4,
wherein the second contact piece includes
a first contact portion that comes into conductive contact with the connection object,
a second contact portion that comes into pressure contact with the substrate connection terminal, and
a spring portion that connects the first contact portion to the second contact portion and exerts a reaction force that presses the first contact portion against the connection object when the second contact portion comes into pressure contact with the substrate connection terminal.

6. The movable connector according to claim 1, wherein the relay terminal includes a projection,
wherein the operation housing has a retaining groove in which the projection is retained in a movable manner with a gap provided therebetween, and
wherein the relay terminal is movable with respect to the operation housing over a range defined by the gap.

7. The movable connector according to claim 1, wherein the substrate connection terminal includes a first base portion held by the movable housing,
wherein the relay terminal includes a second base portion held by the operation housing, and
wherein the first base portion and the second base portion are arranged in a pushing direction in which the operation housing is pushed in the pushing operation.

8. The movable connector according to claim 1, wherein the operation housing and the movable housing include temporarily-fitted-state retaining portions that restrain a movement of the operation housing in a pushing direction in which the operation housing is pushed in the pushing operation and a pulling direction that is opposite to the pushing direction in a temporarily fitted state before the operation housing and the movable housing are combined together in a completely fitted state.

9. The movable connector according to claim 1, wherein the operation housing and the movable housing include completely-fitted-state retaining portions that restrain a movement of the operation housing in a pulling direction in which the operation housing is pulled out of the movable housing in a completely fitted state in which the operation housing and the movable housing are combined together.
